(19) United States
(12) Patent Application Publication
(10) Pub. No.: US 2002/0149796 A1
(43) Pub. Date: Oct. 17, 2002

(54) Facsimile apparatus and information communicating and processing apparatus

(76) Inventor: Yoshiyuki Ominato, Nara-shi (JP)

Correspondence Address: BIRCH STEWART KOLASCH & BIRCH, PO BOX 747, FALLS CHURCH, VA, 22040-0747, US

(21) Appl. No.: 10/101,926

(22) Filed: Mar. 21, 2002

(30) Foreign Application Priority Data
Mar. 21, 2001 (JP) P2001-80865

(51) Int. Cl. H04N 1/00

(52) U.S. Cl. 358/402

(57) ABSTRACT

An object of the invention is to provide a facsimile apparatus and information communicating and processing apparatus that can easily execute centralized administration and detailed control of home appliances and equipment. Home electric appliances such as refrigerator or microwave oven and security-related devices such as door lock sensor or gas sensor are connected with a facsimile apparatus through radio communication according to Bluetooth standard, for administrating and controlling the appliances and devices. Necessary data and instructions are input from operating keys or dial keys, and a control unit outputs control data. Further, it is possible to execute remote control from the exterior or from a cordless slave unit through a telephone line.

### BACKGROUND OF THE INVENTION

1. Field of the Invention

The present invention relates to a facsimile apparatus and information communicating and processing apparatus that can administrate and control home electric appliances and security-related devices.

2. Description of the Related Art

Various proposals have been made regarding a system for administration of a household, for example confirmation of locking status during an absence, or for protection against a fire or intrusion of a burglar, locking from outside in case of having forgotten to lock, or confirmation of status of home electric appliances and of door locks from a single point, and such technique has now been established as security system for practical use. Specific methods for such a system have also been proposed, for example information transmission by wire, by power line or by radio signal including infrared rays, and various devices have been proposed as object of control such as electric appliances, doors, windows, gas sensor, fire sensor, bath unit and so on. Further, methods for controlling each of home appliances and security devices from outside using a telephone through a telephone line, as well as methods for making access to a centralized control unit from a cordless slave unit for administration and controlling have been disclosed.

Japanese Unexamined Patent Publication JP-A 59-52961 (1984) discloses a reliable home communicating apparatus wherein radio transmission is employed when a distribution line is in danger of being cut off for instance by emergence of fire or intrusion of a burglar, while power-line carrier is used for ordinary in-house communication.

Japanese Unexamined Patent Publication JP-A 60-237596 (1985) discloses a home automation system that provides security against accidents and achieves power saving, wherein information of room temperature, bath water temperature, bath water quantity etc. emitted by radio is transmitted as a signal to a home controller placed in another room through a lamp power line.

A switch control apparatus according to the Japanese Unexamined Patent Publication JP-A 61-295836 (1986) and an AC power switching apparatus according to Japanese Unexamined Patent Publication JP-A 63-291327 (1988) respectively discloses an apparatus constituted so as to control by radio transmission a switch connected between a power terminal of a home electric apparatus and a power outlet, to enable remote control of each electric apparatus from a point where the AC power switching apparatus is placed.

Japanese Unexamined Patent Publication JP-A 2-106000 (1990) discloses a home security equipment wherein each protective information emitted by sensors disposed in a house is transmitted by radio at different intervals, in such a manner that the higher the priority of detected information is the shorter transmission interval is allocated, so that all abnormalities can be reported even when two or more sensors have detected abnormalities at the same time.

Japanese Unexamined Patent Publication JP-A 2-158092 (1990) discloses an illuminating system easy to install that accomplishes the optimal illumination and power saving, through remote control of predetermined addresses and light modulating modes by a radio medium instead of illumination control by human sensibility.

Japanese Unexamined Patent Publication JP-A 4-79699 (1992) discloses a home control equipment for centralized control and administration of various apparatus in a room using a wireless medium, by distinction of whether a destination of a radio signal is an apparatus in the room or a home bus (communication bus line of home electronic system) according to packet identification codes of a signal format.

Japanese Unexamined Patent Publication JP-A 5-41745 (1993) discloses a cordless telephone apparatus wherein functions of remote control device incorporated in the telephone apparatus connected to a telephone line are made available to the master unit of the cordless telephone, to enable remote control of home electric appliances by Dial Tone Multi Frequency (hereinafter referred to as DTMF) signals from an outside line, as well as remote control of such appliances by a signal emitted in a different state from that of a voice talk from a slave unit of the cordless telephone.

Japanese Unexamined Patent Publication JP-A 2000-67119 (2000) discloses a home automation system wherein radio signals of a frequency in millimeter wave band are employed to perform non-procedural radio communication and wired bi-directional communication.

As described in the foregoing prior arts, various proposals have been made on home electronic system for improving operability of apparatus related to security and convenience at home such as electric appliances, windows, doors, bathroom, etc., and some of such arts have been applied to security systems and are gradually coming to be popularly used.

However, installation and operation of the apparatus employed in such systems are troublesome, and besides the cost is expensive. Also, though voice information is used for control from outside, sufficient information is not provided to some of the apparatus to be controlled.

### SUMMARY OF THE INVENTION

An object of the invention is to provide a facsimile apparatus and information communicating and processing apparatus that allows easy execution of centralized administration and detailed control of home appliances and equipment.

The invention provides a facsimile apparatus comprising facsimile means for a facsimile function; and centralized administration means for administrating and controlling home electric appliances and security-related devices.

According to the invention, since administration and control of home electric appliances and security-related devices is carried out by the centralized administration means provided in the facsimile apparatus, centralized control of home appliances and equipment can be easily performed. Since the facsimile apparatus can transmit, receive image data and print an image by the facsimile means, detailed control can also be performed.

In the invention it is preferable that the centralized administration means is controlled by a voice signal or Dial Tone Multi Frequency (DTMF) signal from the exterior through a telephone line in relation to the facsimile means.

According to the invention, since the centralized administration means is controlled by the voice signal or DTMF signal from the exterior through the telephone line, remote control from the exterior can be executed.

Also, the invention provides a facsimile apparatus comprising a facsimile apparatus main body including facsimile means for a facsimile function; and centralized administration means for administrating and controlling home electric appliances and security-related devices; and a cordless slave unit connected through a radio line with the facsimile apparatus main body acting as the master unit, wherein the centralized administration means is controlled by the cordless slave unit.

According to the invention, since the cordless slave unit connected through a radio line with the facsimile apparatus main body acting as the master unit can control the centralized administration means, remote control from the cordless slave unit can be executed.

Also, the invention provides a facsimile apparatus comprising a facsimile apparatus main body including facsimile means for a facsimile function, and centralized administration means for administrating and controlling home electric appliances and security-related devices; and detachable operating terminal mounted on the facsimile apparatus main body including communication means for communicating with the facsimile apparatus main body, wherein the operating terminal is provided with display means for displaying administrative status of the centralized administration means and keys for operating the centralized administration means, and the centralized administration means is controlled by communication with the facsimile apparatus main body through the communicating means.

According to the invention, since the detachable operating terminal controls the centralized administration means by communicating with the facsimile apparatus main body through the communicating means, restriction of controlling place is eliminated and flexible control can therefore be executed.

Further, in the invention it is preferable that the communication means is radio communication means that utilizes a frequency band of 2.4 GHz.

According to the invention, since the communication means is radio communication means that utilizes a frequency band of 2.4 GHz, reliable and cost-saving control can be executed.

Further, the invention provides an information communicating and processing apparatus comprising a talking device; radio communication means that utilizes a frequency band of 2.4 GHz; and centralized administration means for administrating and controlling home electric appliances and security-related devices by the radio communication means.

According to the invention, since the information communicating and processing apparatus comprises centralized administration means for administrating and controlling home electric appliances and security-related devices by the radio communication means that utilizes a frequency band of 2.4 GHz, centralized control of home appliances and equipment can be easily executed, and reliable and cost-saving control can also be executed.

Still further, in the invention it is preferable that the information communicating and processing apparatus is connected with a telephone line through the communication means, and the centralized administration means is controlled by a voice signal or DTMF signal from the exterior.

According to the invention, since the centralized administration means is operated by the voice signal or DTMF signal from the exterior through a telephone line, remote control from the exterior can be executed.

Still further, in the invention it is preferable that the information communicating and processing apparatus further comprises a main body of information communicating and processing apparatus provided with the centralized administration means, and a cordless slave unit connected through a radio line with the main body of information communicating and processing apparatus acting as the master unit, wherein the centralized administration means is controlled from the cordless slave unit.

According to the invention, since the centralized administration means is operated from the cordless slave unit connected through a radio line with the information communicating and processing apparatus main body acting as the master unit, remote control from the cordless slave unit can be executed.

According to the invention, since centralized administration of home appliances and equipment can be easily executed and the facsimile apparatus can transmit and receive image data and print an image, detailed control can also be performed.

According to the invention, remote control from the exterior through a telephone line can be executed.

Also according to the invention, remote control from a cordless slave unit can be executed.

Further, according to the invention, restriction of controlling place is eliminated and flexible control can therefore be executed.

Further, according to the invention, reliable and cost-saving control can be executed.

### BRIEF DESCRIPTION OF THE DRAWINGS

Other and further objects, features, and advantages of the invention will be more explicit from the following detailed description taken with reference to the drawings wherein:

FIG. 1 is a conceptual drawing of a home electronic system including a facsimile apparatus according to an embodiment of the present invention;

FIG. 2 is a block diagram showing a constitution of the facsimile apparatus;

FIGS. 3A to 3C are conceptual drawings showing examples of connection of apparatus according to Bluetooth standard; and

FIG. 4 is a perspective view showing the facsimile apparatus.

### DETAILED DESCRIPTION OF THE PREFERRED EMBODIMENTS

Now referring to the drawings, preferred embodiments of the invention are described below.

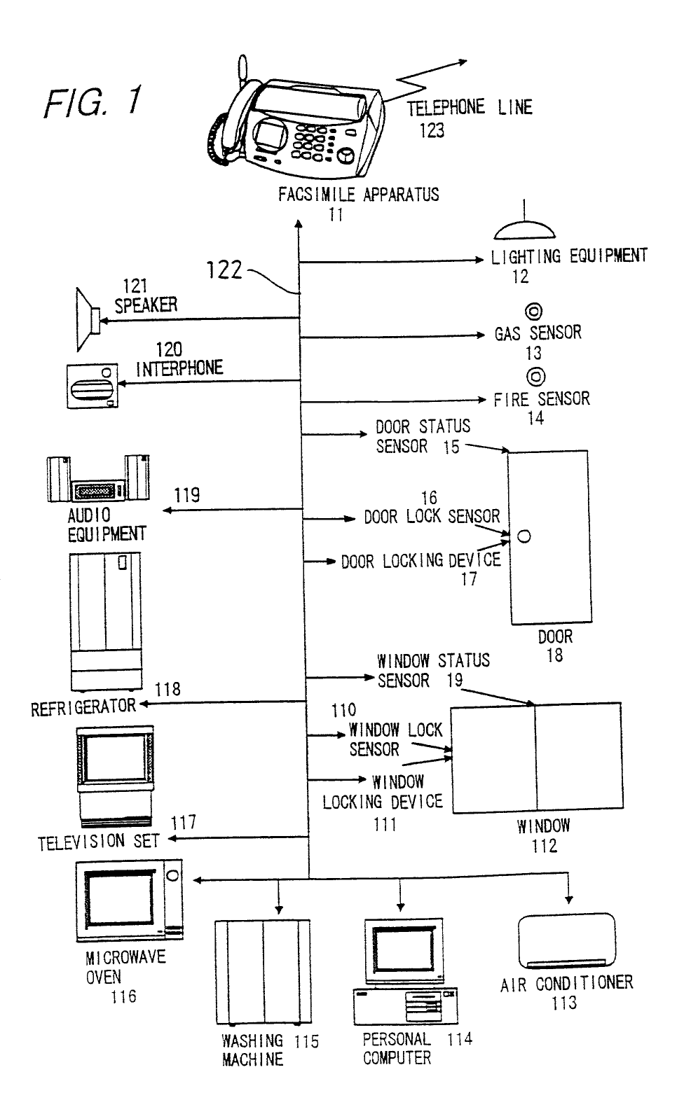

FIG. 1 is a conceptual drawing of a home electronic system including a facsimile apparatus according to an embodiment of the present invention. Home appliances and apparatus are controlled in a centralized manner by the facsimile apparatus 11. The facsimile apparatus 11 is provided with all the functions required for home administration since it can input and output image data and other kinds of data, and perform talks and communications with outside as well as with a slave unit, besides along with the increasing popularity of domestic facsimile apparatus in addition to office-use ones the facsimile apparatus as a whole have become widely used, therefore the facsimile apparatus is optimum for the object of centralized administration.

The administration and control of security-related devices include an emergency announcement from a speaker 121 activated in responsive to an emergency alarm from a gas sensor 13 or a fire sensor 14 or both thereof, and centralized administration of the status of a door 18, as well as control of locking and unlocking from the exterior during an absence by a door status sensor 15 for detecting open and closed state of the door 18, a door lock sensor 16 for detecting locking status and door locking device 17 for locking the door in compliance with an instruction. In addition, it is possible to automatically cut off power supply or gas supply by warning information from the fire sensor 14 or the gas sensor 13 or both thereof, and to control from exterior through a telephone line 123 or a cordless slave unit. In case where opening and closing of the door 18 itself can be automatically controlled, more functions will be practicable.

A window 112 is similarly controlled to the door 18. The window 112 has a window status sensor 19, window lock sensor 110 and window locking device 111. Confirmation of open or closed state of each window by the window status sensor 19, confirmation of locking status by the window lock sensor 16, locking and unlocking by the window locking device 111, and further locking through the telephone line 123 or cordless slave unit can be administrated. In the aspect of administration of home electric appliances, it is possible to control light volume of lighting equipment, to confirm whether the power has been turned off, and to administrate and control an air conditioner 113, washing machine 115, microwave oven 116, television set 117, refrigerator 118 and audio equipment 119, etc.

Among these electric appliances, more of them are coming to be equipped with display devices. For example, the refrigerator 118 can display food inventory status and the microwave oven 116 can display cooking recipes. Therefore in order to execute more detailed administration of electric appliances it is necessary to incorporate functions of transmitting and receiving image data and printing. The facsimile apparatus 11 has the function of reading, printing, transmitting and receiving image data. Utilizing such functions many control points can be added, for instance transmitting an image taken by the interphone 120 at the front door for checking at a different place.

Now, methods of transmission of administrative information on these electric appliances and security-related devices shall be described hereunder. It is preferable that the facsimile apparatus 11 according to the invention employs Bluetooth radio transmission line 122 as radio communication means with the electric appliances and security-related devices. Radio communication according to Bluetooth standard can make connection over a short range of approx. 10 meters at a maximum data transmission speed of 1 Mbit/second. This is therefore a suitable radio communication standard for domestic communication from the viewpoint of range and speed of communication. Further, connection and adjustment of devices necessary for the radio communication can be easily executed. In addition, since installation work is not required and the necessary devices are inexpensive, the cost for introduction can be lowered.

That is, the facsimile apparatus 11 is a device for Bluetooth, and the electric appliances and security-related devices 12, 13, 14, 15, 16, 17, 19, 110, 111, 113, 114, 115, 116, 117, 118, 119, 120 and 121 are also devices for Bluetooth. The facsimile apparatus 11 and the electric appliances and security-related devices 12 to 17, 19, 110, 111 and 113 to 121 are provided with communication means for performing radio communication for the Bluetooth standard, respectively. The facsimile apparatus 11 and the electric appliances and security-related devices 12 to 17, 19, 110, 111 and 113 to 121 are connected with each other by radio communication for the Bluetooth standard, and functions of these devices for Bluetooth are recognized in accordance with Generic Access Profile (GAP) and Service Discovery Profile (SDP), etc.

As shown in the conceptual drawing of FIG. 1 it is preferable to connect a personal computer 114, because the personal computer 114 for home use is very popular today and information processing and data communication with outside can be performed by the personal computer 114. For example it is possible to administrate home electric appliances and security-related devices through the facsimile apparatus 11 by an e-mail from the personal computer 114, or to administrate and control them by the personal computer 114 itself and to read out a data outside of the home.

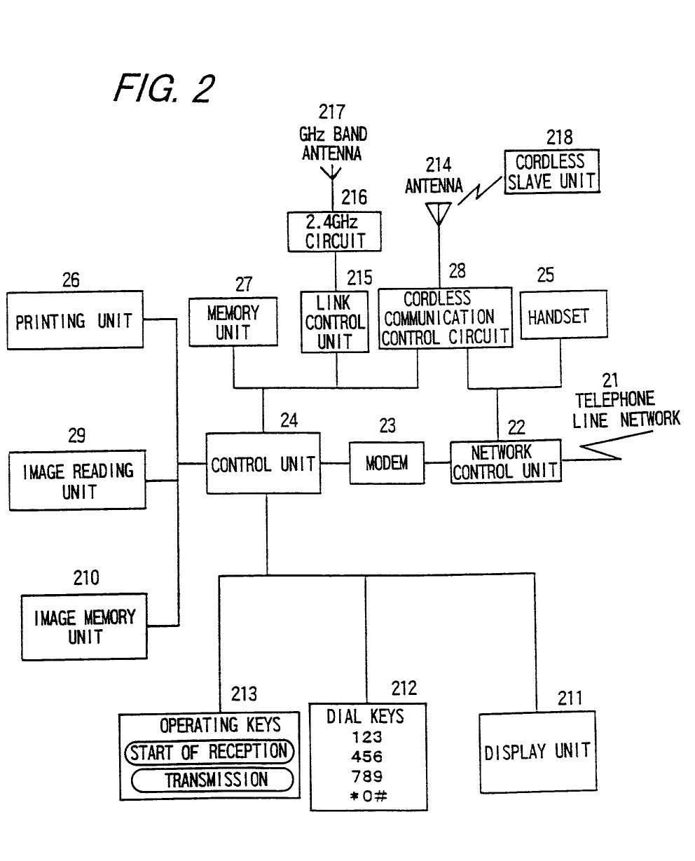

FIG. 2 is a block diagram showing a constitution of the facsimile apparatus 11. The facsimile apparatus 11 is constituted of a network control unit 22, modem 23, control unit 24, handset 25, printing unit 26, memory unit 27, cordless communication control circuit 28, image reading unit 29, image memory unit 210, display unit 211, dial keys 212, operating keys 213, antenna 214, link control unit 215, 2.4 GHz circuit 216 and GHz band antenna 217. In the embodiment, facsimile means, which may be minimum components for a facsimile function, comprises the network control unit 22, the modem 23, the control unit 24, memory unit 27, the printing unit 26, the image reading unit 29, and the image memory unit 210. The facsimile apparatus 11 is connected with a telephone line network 21 through the network control unit 22. The network control unit 22 supervises the status of the telephone line network 21, and switches the circuit to the side of the modem 23, or the side of the handset 25 and cordless communication control circuit 28. The modem 23 modulates digital signals of image data into analogue signals suitable for the telephone line network 21, and demodulates analogue signals from the telephone line network 21 into digital signals for printing.

The printing unit 26 serves for printing image data that has been received or read out, and popular printing methods are thermal printing, electro-photography, ink-jet printing, etc. The image reading unit 29 works for reading out materials for transmission or copying, and methods for reading out include reduction reading system by a combination of a lens and CCD (Charge Coupled Device) line sensor, contact sensor system by rod lens array, etc.

The image memory unit 210 is a unit for memorizing image data that has been read out or received, by which many upgrading functions will be practicable such as transference of received image, multiple address transmission, interception when printing paper has run out, memory transmission, etc.

The control unit 24 determines actions of the entire apparatus, emits instructions to the entire apparatus including displaying instructions to the display unit 211 in accordance with programs stored in the memory unit 27, based on input information from the operating keys 213 and dial keys 212, information on the status of each unit of the apparatus and information of signals from the telephone line network 21, etc. Also, the control unit 24 is engaged in compression of the image data to shorten a data transmission time, and extension of the compressed data to restore the original pixel array information.

Further, the functions required from centralized administration means, transmission and reception of data for processing domestic information to and from the cordless slave unit 218, and transmission and reception of such data between the facsimile apparatus 11 and the exterior are controlled according to the program stored in the memory unit 27, and control signals are output to the electric appliances and security-related devices through the link control unit 215, the result of which is output by the display unit 211 or printing unit 26 as the case may be.

The operating keys 213 and dial keys 212 are the units by which a user can input controlling information and instruction to the apparatus. The display unit 211 displays the administrative status and operational guidance to the user, and by utilizing the display unit 211 in combination with the operating keys 213 and dial keys various parameters of the facsimile apparatus 11 can be set. In addition, in order to make a centralized administration in home, it is preferable to employ a large screen capable of displaying images as display unit 211.

The handset 25 is provided with a receiver and transmitter for a telephone talk. The facsimile apparatus according to this embodiment can be connected with one or a plurality of cordless slave units. The cordless communication control circuit 28 is a unit that controls the communication with a cordless slave unit 218, provided with a tuner for searching a communication channel for connection with a cordless slave unit 25, establishing the connection, voice talk and for wave transmission and reception. The antenna 214 transmits and receives the wave by which the transmission and reception is performed with a slave unit.

The radio communication means that employs a frequency band of 2.4 GHz, which satisfies the Bluetooth standard, is constituted of the link control circuit 215 for controlling the communication, the 2.4 GHz circuit 216 that has a tuner function and the GHz band antenna 217 for transmitting and receiving the wave by which the communication is performed with the respective units to be controlled. By these units the control data of home appliances and devices output by the control unit 24, as well as alarms and status data transmitted by the respective appliances and devices can be transmitted and received.

The Bluetooth standard has been established to perform an inexpensive and power-saving link to connect various units by a short-range radio wave, and represents a transmission method of data and voice employing an ISM (Industrial Scientific Medicine) band of 2.4 GHz band. For practical use, a frequency band of not less than 2.400 GHz and not more than 2.4835 GHz is specified as frequency for a radio station utilizing a small power data communication system. In addition to the above, it is also possible to use a frequency band of not less than 2.471 GHz and not more than 2.497 GHz. It is therefore preferable to apply this Bluetooth standard to a domestic information administration system (home automation system).

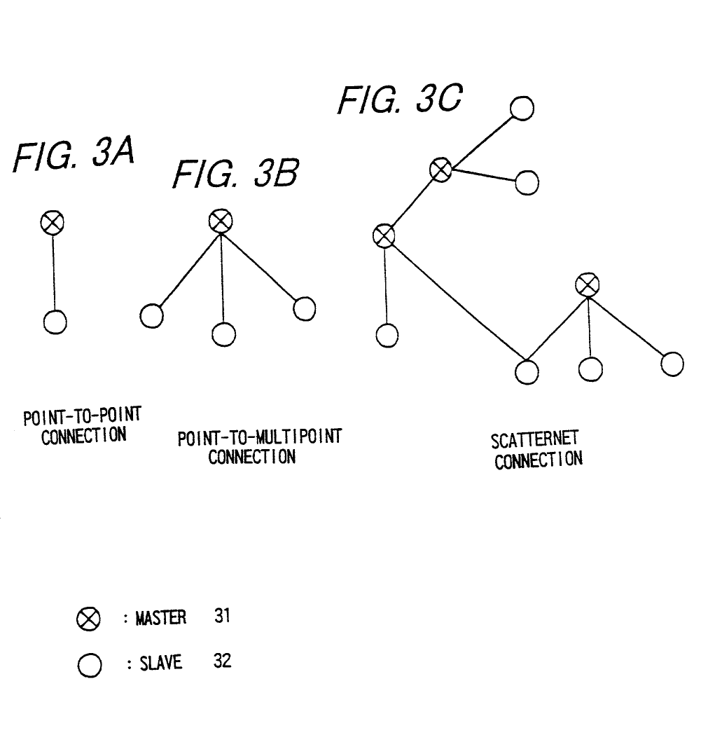

FIGS. 3A to 3C are conceptual drawings showing examples of connection of apparatus according to the Bluetooth standard. The FIG. 3A shows a point-to-point connection whereby a master 31 and a slave 32 are connected one-to-one; FIG. 3B shows a point-to-multipoint connection that is a communication circuit network called piconet, whereby a master 31 is connected with a plurality of slaves 32 for simultaneous communication with the slaves; and FIG. 3C shows a scatternet that is a combination of a plurality of piconets. In the scatternet, flexible connection can be performed, because for example a master 31 of one piconet can also serve as a slave 32 of another piconet.

It is preferable to adopt the packet system for data transmission, so that data is modulated in frequency modulation (FM) and transmitted at 625 μs per packet and at a data transference speed of 1 MB per second. Transmission is executed alternately to the master 31 and to the slave 32, while it is also possible to consecutively transmit a data corresponding to 5 packets at maximum. The transmission frequency is switched for each packet by frequency hopping to improve reliability of the transmission.

The reliability of data and voice transmission can be further enhanced by adopting CRC (Cyclic Redundancy Check) error detecting system, by which retransmission can be demanded in case an error has been found. Also, when voice data is being transmitted the transmission speed is 64 kbps, and one of the following three communication modes can be selected as the case may be, namely ⅓ error correction mode by which errors of all the bits can be corrected, ⅔ error correction mode by which an error of 1 bit per every 10 bits can be corrected and 2 bits per every 10 bits can be detected, and non-correction mode. Further, in case where information is transmitted by broadcasting from a master to a slave the transmission is repeated a plurality of times.

As described above the Bluetooth standard is a very suitable system of transmission for radio communication of domestic data and voice, and by adopting these standardized specifications the installation of the apparatus necessary for communication can be achieved at a low cost.

Methods for controlling home electric appliances and security-related devices through the operation of the control unit 24 of the facsimile apparatus 11 from the telephone line 123 or the cordless slave unit 218 shall now be described hereunder. For connection from the exterior through the telephone line 123, when a call is made from the exterior to the facsimile apparatus 11, the control unit 24 activates data communication mode in responsive to DTMF signals formed of a specific combination of for example #, * and numeral keys, then upon confirmation of the user by an ID code, the control unit 24 executes administration and control of home electric appliances and security-related devices in responsive to voice signals or DTMF signals. For controlling by voice signals, the facsimile apparatus 11 must be equipped in advance with a function of voice recognition.

Likewise, in the case of connection from the cordless slave unit 218, since the cordless slave unit 218 and the facsimile apparatus 11 acting as the master unit are executing data transmission during the preliminary steps of identification of apparatus number etc., data communication between the cordless slave unit 218 and the master unit can be easily performed as an extension of the preliminary steps. Accordingly remote administration and control of home electric appliances and security-related devices by the cordless slave unit 218 can be similarly executed to the communication through the telephone line 123 by the same procedure.

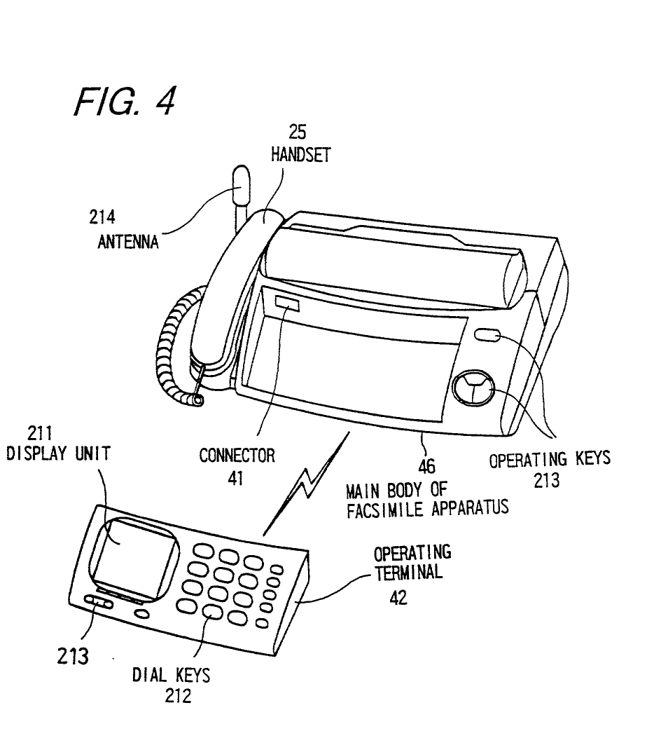

FIG. 4 is a perspective view showing the facsimile apparatus 11. The display unit 211, dial keys 212 and apart of the operating keys 213 are detachable from the facsimile apparatus 11 main body. These parts constitute the operating terminal 42. Such operating terminal 42 and the facsimile apparatus main body 46 are connected by wire or radio wave. In the case of radio communication, the operating terminal 42 is equipped with a chargeable battery for activating the terminal. This battery is charged through a connector 41 when the operating terminal 42 is mounted on the facsimile apparatus main body 46. The administration and control of the home electric appliances and security-related devices can be executed through the control unit 24 in the facsimile apparatus main body 46 by inputting data from dial keys 212 and operating keys 213 according to administrative status shown in the display unit 211 on the operating terminal 42. It is also preferable that the operating terminal 42 and the facsimile apparatus main body 46 make radio communications according to the Bluetooth standard, in which case it is necessary to incorporate communication means in compliance with the Bluetooth standard in the operating terminal 42.

The invention maybe embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A facsimile apparatus comprising:
facsimile means for a facsimile function; and
centralized administration means for administrating and controlling home electric appliances and security-related devices.

2. The facsimile apparatus of claim 1, wherein the centralized administration means is controlled by a voice signal or Dial Tone Multi Frequency (DTMF) signal from the exterior through a telephone line in relation to the facsimile means.

3. A facsimile apparatus comprising:
a facsimile apparatus main body including facsimile means for a facsimile function, and centralized administration means for administrating and controlling home electric appliances and security-related devices, the facsimile apparatus main body acting as a master unit; and
a cordless slave unit connected through a radio line with the facsimile apparatus main body,
wherein the centralized administration means is controlled by the cordless slave unit.

4. A facsimile apparatus comprising:
a facsimile apparatus main body including facsimile means for a facsimile function, and centralized administration means for administrating and controlling home electric appliances and security-related devices; and
detachable operating terminal mounted on the facsimile apparatus main body including communication means for communicating with the facsimile apparatus main body,
wherein the operating terminal is provided with display means for displaying administrative status of the centralized administration means and keys for operating the centralized administration means, and the centralized administration means is controlled by communication with the facsimile apparatus main body through the communicating means.

5. The facsimile apparatus of claim 4, wherein the communication means is radio communication means that utilizes a frequency band of 2.4 GHz.

6. An information communicating and processing apparatus comprising:
a talking device;
radio communication means that utilizes a frequency band of 2.4 GHz; and
centralized administration means for administrating and controlling home electric appliances and security-related devices by the radio communication means.

7. The information communicating and processing apparatus of claim 6, wherein the information communicating and processing apparatus is connected with a telephone line through the communication means, and the centralized administration means is controlled by a voice signal or DTMF signal from the exterior.

8. The information communicating and processing apparatus of claim 6, further comprising:
an information communicating and processing apparatus main body provided with the centralized administration means, the information communicating and processing apparatus main body acting as a master unit; and
a cordless slave unit connected through a radio line with the information communicating and processing apparatus main body,
wherein the centralized administration means is controlled from the cordless slave unit.
